(19) United States
(12) Patent Application Publication
(10) Pub. No.: US 2018/0249673 A1
(43) Pub. Date: Sep. 6, 2018

(54) Animal Harness

(71) Applicant: Donetta Sue Contreras, Bonita Springs, FL (US)

(72) Inventor: Donetta Sue Contreras, Bonita Springs, FL (US)

(21) Appl. No.: 15/911,049

(22) Filed: Mar. 2, 2018

Related U.S. Application Data
(60) Provisional application No. 62/466,186, filed on Mar. 2, 2017.

(51) Int. Cl. A01K 1/02; A01K 27/00; A01K 13/00

(52) U.S. Cl. CPC A01K 1/0263; A01K 27/002; A01K 27/005; A01K 27/003; A01K 13/006; A01K 27/008

(57) ABSTRACT

An animal harness that wraps around a four-legged animal includes a fabric body and an adaptable leash to be used as a standard leash or a shoulder strap for carrying an animal within the fabric body. The fabric body has a front pair of leg holes and a rear pair of leg holes for accommodating the limbs of the animal, and a urinary hole for accommodating male genitalia. A concave V-shaped section in the back of the fabric body allows the fabric body to split when the animal squats, allowing the animal to freely urinate or defecate. A first wrap fastener and a second wrap fastener are secured to opposing surfaces of the fabric body and allows the fabric body to be secured around the animal. The adaptable leash can be coupled to the fabric body through a front pair of leash fasteners and/or a rear pair of leash fasteners.

The current application claims a priority to the U.S. Provisional Patent application Ser. No. 62/466,186 filed on Mar. 2, 2017.

### FIELD OF THE INVENTION

The present invention relates generally to animal accessories. More specifically, the present invention is an animal harness that wraps around the torso of a four-legged animal.

### BACKGROUND OF THE INVENTION

Many people in the present day own small pets such as dog and cats. The owners of the small pets usually take out their pets and carry them around when not walking them. Female owners of pets, in particular, carry around their small pets in either their purse or a small bag. Some pets may be too big for the purse of an owner or just too big for a small bag in general. It also is uncomfortable for the pet to be inside of a small bag or purse due to their limbs being concealed and compressed within the small bag or purse. Some small pets also have a difficult time controlling their bladder and may have an accident while in a small bag or purse. The user is then in discomfort due to the pet having an accident though the pet did not have control or a free means to urinate.

Therefore, it is an object of the present invention to provide a more efficient and comfortable method of carrying a pet. The present invention has a fabric body that wraps around the torso of an animal and includes a plurality of openings for the legs of the pet to pass through the fabric body. Additionally, the present invention includes an adaptable leash that can be used as a standard leash or as a shoulder strap for the user to comfortably carry the pet. The present invention also helps keep the back muscles of a pet strong and healthy by evenly distributing forces through the fabric body and maintaining the pet's spine in a natural, straight alignment. Furthermore, the present invention includes a V-shaped cut in the back of the fabric body which allows the pet to easily and freely urinate without soiling the fabric body. The user will not be in discomfort due to any accidents that may occur and the pet will have a means to urinate without any restraint.

### BRIEF DESCRIPTION OF THE DRAWINGS

FIG. 1 is a perspective view of the present invention, wherein the fabric body is configured as if worn by an animal.

FIG. 2 is a rear elevational view of the present invention.

FIG. 3 is a front elevational view of the present invention, wherein the adjustment strap is connected to the first strap fastener and the second strap fastener.

FIG. 4 is a top plan view of the present invention.

FIG. 5 is a right side view of the present invention.

FIG. 6 is a left side view of the present invention.

FIG. 7 is a top plan view of the present invention, wherein the fabric body is laid flat.

FIG. 8 is a bottom plan view of the present invention, wherein the fabric body is laid flat.

FIG. 9 is a perspective view of the present invention, wherein the item pouch is attached to one of the front pair of leash fasteners.

### DETAIL DESCRIPTIONS OF THE INVENTION

All illustrations of the drawings are for the purpose of describing selected versions of the present invention and are not intended to limit the scope of the present invention.

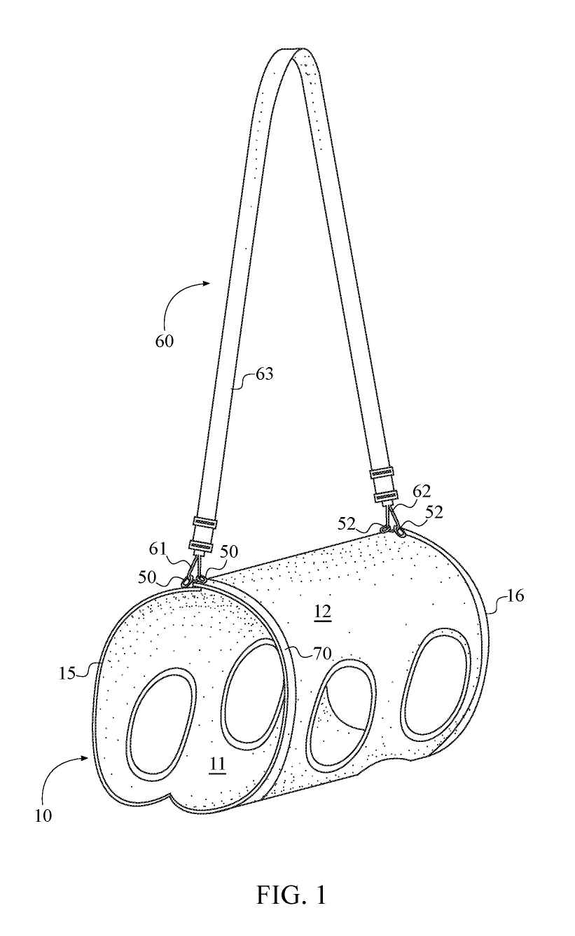

The present invention is an animal harness that wraps around the torso of a four-legged animal. In the preferred implementation, the present invention is configured for use with dogs. However, it is possible for the present invention to be configured for use with other four-legged animals, such as horses, cats, etc. In reference to FIG. 1, the present invention comprises a fabric body 10 and an adaptable leash 60. The fabric body 10 is wrapped around the torso of the animal, wherein the fabric body 10 induces a smothering effect to calm the animal. The adjustable leash is coupled to the fabric body 10 and can be used as a standard leash or as a shoulder strap to carry the animal.

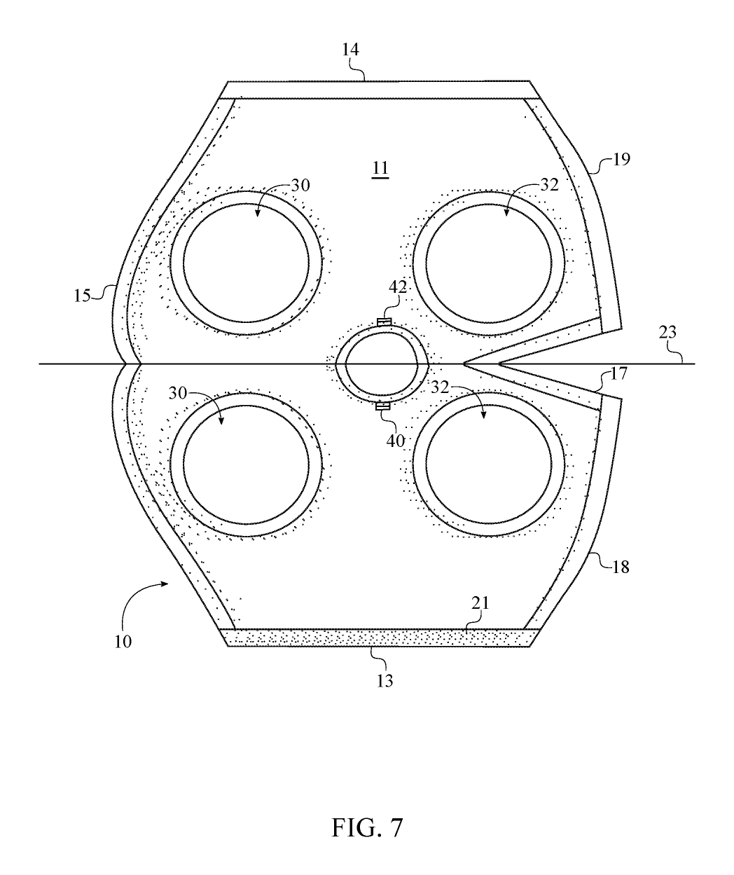

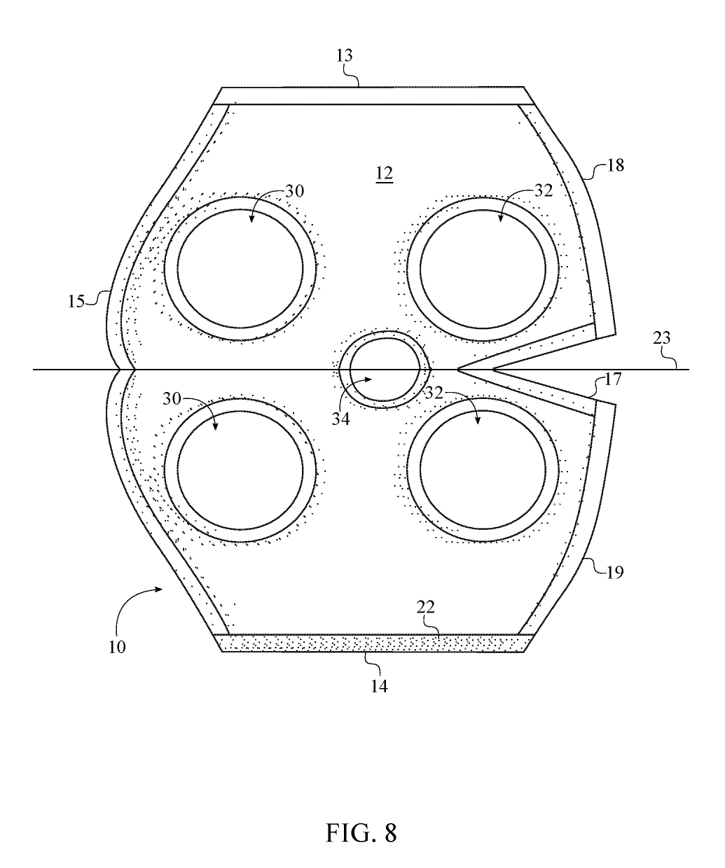

In reference to FIG. 7-8, the fabric body 10 comprises a top-inner surface 11, a bottom-outer surface 12, a first side edge 13, a second side edge 14, a convex front edge 15, a back edge 16, a first wrap fastener 21, and a second wrap fastener 22. The top-inner surface 11 is the upwards facing surface when the fabric body 10 is laid flat to be secured around the animal and is the inner facing surface when the fabric is secured around the torso of the animal. Conversely, the bottom-outer surface 12 is the downwards facing surface when the fabric body 10 is laid flat to be secured around the animal and is the outer facing surface when the fabric is secured around the torso of the animal. Meanwhile, the first side edge 13, the second side edge 14, the convex front edge 15, and the back edge 16 form the perimeter of the fabric body 10. The first wrap fastener 21 and the second wrap fastener 22 are used to secure the fabric body 10 closed around the animal.

When used with an animal, the convex front edge 15 is oriented towards the front of the animal, while the back edge 16 is oriented towards the rear of the animal.

Meanwhile, the first side edge 13 and the second side edge 14 are oriented on opposing sides of the animal before the present invention is attached to the animal, and aligned with the animal's spine when the present invention is secured around the animal. The convex front edge 15 is contoured to support the front of the animal's shoulders and the front-lower chest of the animal. In this way, the fabric body 10 does not choke the animal when using the adaptable leash 60 as either a standard leash or a shoulder strap. The back edge 16 is contoured in a manner that allows the fabric body 10 to split apart when the animal squats, thus allowing the animal to urinate or defecate without soiling the fabric body 10.

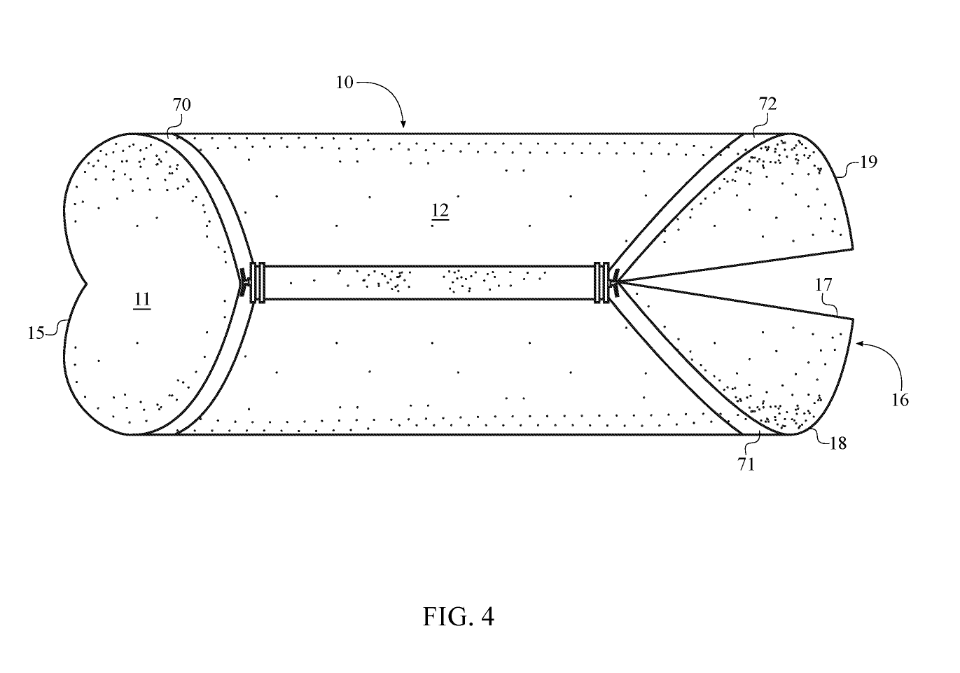

More specifically and in reference to FIG. 4 and FIG. 7-8, the back edge 16 comprises a concave V-shaped section 17, a first convex section 18, and a second convex section 19. The concave V-shaped section 17 forms the middle section of the back edge 16, wherein the first convex section 18 is connected in between the first side edge 13 and the concave V-shaped section 17 and the second convex section 19 is connected in between the second side edge 14 and the concave V-shaped section 17. The concave V-shaped section 17 is centered along the length of the back edge 16 and is centered about the sagittal plane 23 of the fabric body 10. In this way, the concave V-shaped section 17 allows the fabric body 10 to split evenly about both sides of the animal's posterior, when the animal urinates or defecates. Furthermore, the first convex section 18 and the second convex section 19 are contoured to support the back of the animal's hips and the posterior of the animal.

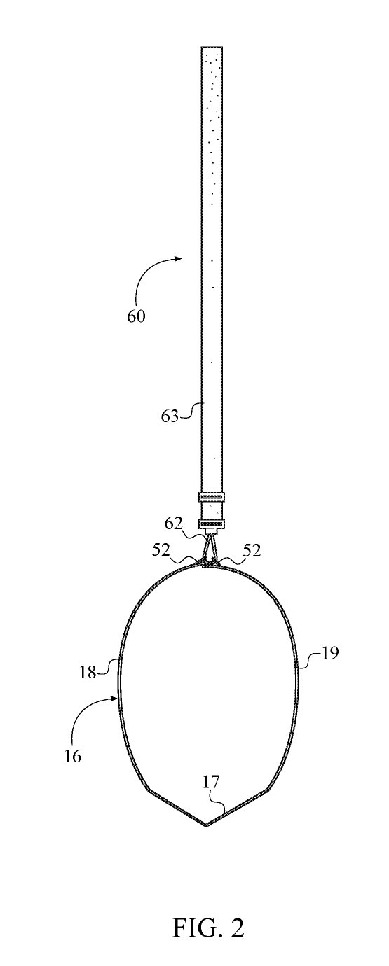

The first wrap fastener 21 and the second wrap fastener 22 are used to secure the first side edge 13 and the second side edge 14 together, when the fabric body 10 is wrapped around the animal, as depicted in FIG. 1-3. As such, the first wrap fastener 21 is positioned along the first side edge 13 while the second wrap fastener 22 is positioned along the second side edge 14. In some embodiments of the present invention, the first wrap fastener 21 is adjacently connected to the top-inner surface 11, while the second wrap fastener 22 is adjacently connected to the bottom-outer surface 12, as depicted in FIG. 7-8. In this way, the first side edge 13 and the second side edge 14 overlap, wherein the first side edge 13 is positioned on top of the second side edge 14. In such embodiments, the first wrap fastener 21 and the second wrap fastener 22 may be opposing hook and loop fasteners; if the first wrap fastener 21 is a hook fastener, then the second warp fastener is a loop fastener, and vice versa.

The first side edge 13 and the second side edge 14 are straight edges that are parallel with each other. When the present invention is secured to an animal, the first wrap fastener 21 is engaged with the second wrap fastener 22, wherein the first side edge 13 and the second side edge 14 are aligned down the spine of the animal. As the fabric body 10 is symmetrical about the sagittal plane 23, the alignment of the first side edge 13 and the second side edge 14 with the spine of the animal ensures that the weight of the animal or any force applied to the animal via the adaptable leash 60 is evenly distributed about the fabric body 10.

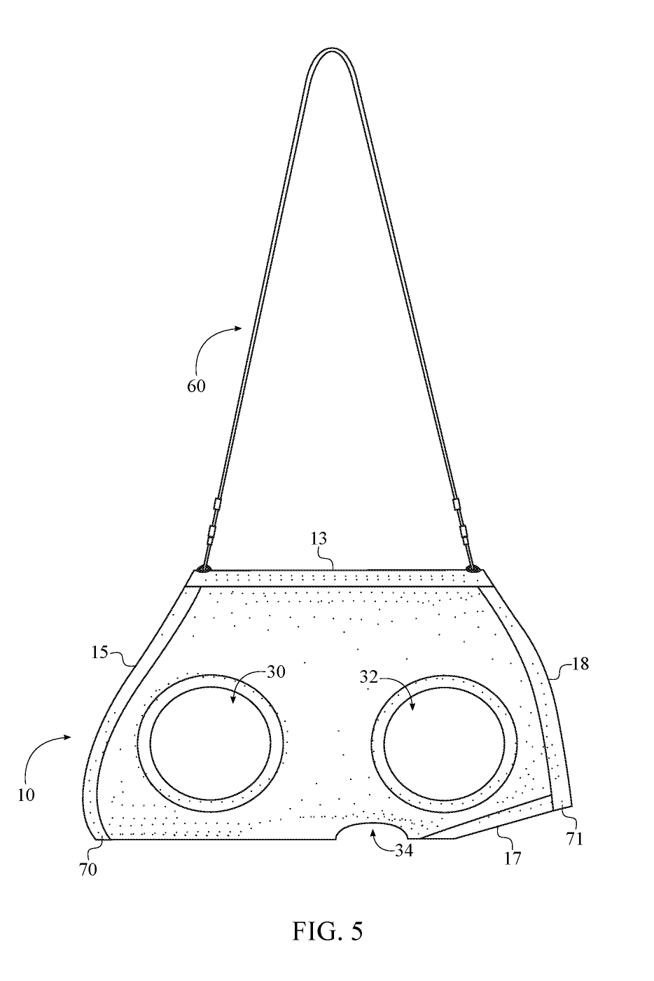

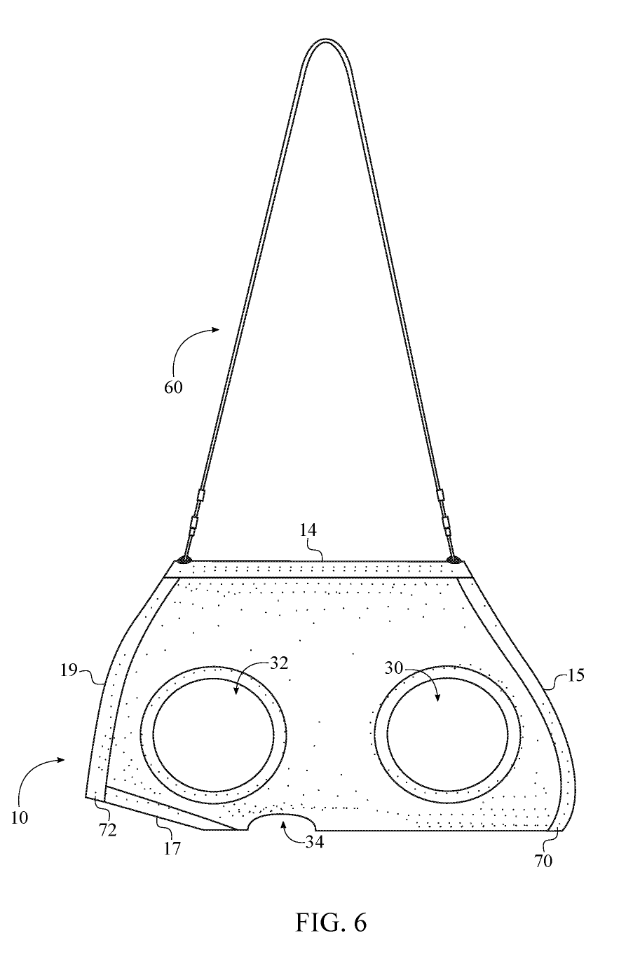

In reference to FIG. 5-6, the present invention further comprises a front pair of leg holes 30, a rear pair of leg holes 32, and a urinary hole 34. The front pair of leg holes 30 and the rear pair of leg holes 32 traverse through the fabric body 10; the front pair of leg holes 30 providing passage of the animal's front legs through the fabric body 10 and the rear pair of leg holes 32 providing passage of the animal's rear legs through the fabric body 10. As such, the front pair of leg holes 30 is positioned adjacent to the convex front edge 15, while the rear pair of leg holes 32 is positioned adjacent to the back edge 16. Each of the front pair of leg hole mirrors the other about the sagittal plane 23 of the fabric body 10. Similarly, each of the rear pair of leg holes 32 mirrors the other about the sagittal plane 23 of the fabric body 10. The symmetry of the front pair of leg holes 30 and the rear pair of leg holes 32 matches the natural symmetry of the animal, thus ensuring the animal's legs are able to comfortably pass through the fabric body 10.

Similar to the front pair of leg holes 30 and the rear pair of leg holes 32, the urinary hole 34 traverses through the fabric body 10, wherein the urinary hole 34 provides passage of a male animal's genitals through the fabric body 10. As such, the urinary hole 34 is positioned in between the front pair of leg holes 30 and the rear pair of leg holes 32, wherein the urinary hole 34 is adjacent to the rear pair of rear leg holes and offset from the front pair of leg holes 30. Furthermore, the urinary hole 34 is centered about the sagittal plane 23 of the fabric body 10, as depicted in FIG. 7-8; the sagittal plane 23 bisecting the urinary hole 34. This alignment of the urinary hole 34 along the fabric body 10 ensures that the positioning of the urinary hole 34 matches the anatomy of the animal, allowing the animal's genitals to comfortably pass through the fabric body 10, when the fabric body 10 is secured to the animal.

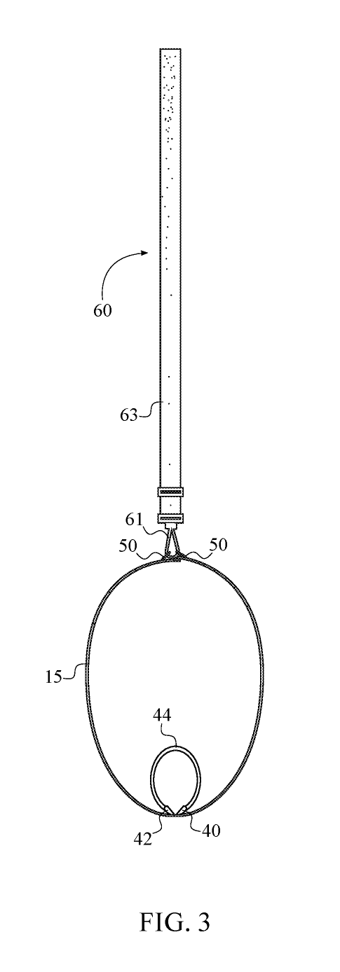

For some less endowed animals, the urinary hole 34 may sag too much below the animal's genitals, thus making it easier for the fabric body 10 to be soiled when the animal urinates. In reference to FIG. 3 and FIG. 7, to prevent such unnecessary and unwanted soiling, the present invention further comprises a first strap fastener 40, a second strap fastener 42, and an adjustment strap 44. The first strap fastener 40 and the second strap fastener 42 are adjacently connected to the top-inner surface 11 and are positioned adjacent to the urinary hole 34. The first strap fastener 40 and the second strap fastener 42 are diametrically opposed to each other about the urinary hole 34, wherein the first strap fastener 40 is positioned in between the first side edge 13 and the urinary hole 34 and the second strap fastener 42 is positioned in between the second side edge 14 and the urinary hole 34.

The adjustment strap 44 is used in conjunction with the first strap fastener 40 and the second strap fastener 42 to lift the material of the fabric body 10 around the urinary hole 34 closer to the animal's torso. When implemented, the adjustment strap 44 is terminally connected to the first strap fastener 40 and the second strap fastener 42, wherein the adjustment strap 44 is positioned around the animal's torso. To utilize the adjustment strap 44, one end of the adjustment strap 44 is first attached to either the first strap fastener 40 or the second strap fastener 42. The adjustment strap 44 is then pulled around the torso of the animal and the other end of the adjustment strap 44 is attached to the other fastener. In some embodiments of the present invention, the adjustment strap 44 is elastic, such that the adjustment strap 44 is able to stretch around the animal and pull the fabric body 10 upwards, against the animal's torso. In other embodiments, the adjustment strap 44 may have a slide or other means for adjusting the length of the adjustment strap 44.

In reference to FIG. 1-3, to couple the adaptable leash 60 to the fabric body 10, the present invention further comprises a front pair of leash fasteners 50 and a rear pair of leash fasteners 52. Both the front pair of leash fasteners 50 and the rear pair of leash fasteners 52 are mounted to the bottom-outer surface 12, such that the front pair of leash fasteners 50 and the rear pair of leash fasteners 52 are accessible when the fabric body 10 is secured about the animal. The front pair of leash fasteners 50 is positioned adjacent to the convex front edge 15, while the rear pair of leash fasteners 52 is positioned adjacent to the back edge 16. Each of the front pair of leash fasteners 50 is positioned on an opposite side of the fabric body 10, when the fabric body 10 is laid flat. In this way, each of the front pair of leash fasteners 50 is positioned adjacent to the other when the fabric body 10 is secured around the torso of the animal. Similarly, each of the rear pair of leash fasteners 52 is positioned on an opposite side of the fabric body 10, when the fabric body 10 is laid flat. In this way, each of the rear pair of leash fasteners 52 is positioned adjacent to the other when the fabric body 10 is secured around the torso of the animal.

In reference to FIG. 4, in some embodiments, the present invention further comprises a front edge reinforcement 70, a first back edge reinforcement 71, and a second back edge reinforcement 72. The front edge reinforcement 70 is for mounting the front pair of leash fasteners 50 to the fabric body 10, while the first back edge reinforcement 71 and the second back edge reinforcement 72 are for mounting the rear pair of leash fasteners 52 to the fabric body 10. Furthermore, the front edge reinforcement 70 provides additional structural stability to the fabric body 10 along the convex front edge 15, while the first back edge reinforcement 71 and the second back edge reinforcement 72 provide additional structural stability to the fabric body 10 along the back edge 16. More specifically, the first back edge reinforcement 71 provides stability along the first convex section 18 and the second back edge reinforcement 72 provides stability along the second convex section 19.

The front edge reinforcement 70 is adjacently connected to the bottom-outer surface 12, along the convex front edge 15. The front edge reinforcement 70 is a length of material that is sewn, or otherwise affixed, to the fabric body 10. Each of the front pair of leash fasteners 50 is coupled to an opposing end of the front edge reinforcement 70. In this way, each of the front pair of leash fasteners 50 is brought adjacent to the other when the fabric body 10 is secured around the animal, thus allowing the adaptable leash 60 to be simultaneously coupled to each of the front pair of leash fasteners 50. Each of the front pair of leash fasteners 50 may be a D-ring, O-ring, or other member that allows the adaptable leash 60 to be removably attached.

Meanwhile, the first back edge reinforcement 71 is adjacently connected to bottom-outer surface 12 along the back edge 16, in between the first side edge 13 and the concave V-shaped section 17. Similarly, the second back edge reinforcement 72 is adjacently connected to the bottom-outer surface 12 along the back edge 16, in between the second side edge 14 and the concave V-shaped section 17. Both the first back edge reinforcement 71 and the second back edge reinforcement 72 are sewn, or otherwise affixed, to the fabric body 10. One of the rear pair of leash fasteners 52 is terminally coupled to the first back edge reinforcement 71 adjacent to the first side edge 13 and one of the rear pair of leash fasteners 52 is terminally coupled to the second back edge reinforcement 72 adjacent to the second side edge 14. In this way, each of the rear pair of leash fasteners 52 is brought adjacent to the other when the fabric body 10 is secured around the animal, thus allowing the adaptable leash 60 to be simultaneously coupled to each of the rear pair of leash fasteners 52. Each of the rear pair of leash fasteners 52 may be a D-ring, O-ring, or other member that allows the adaptable leash 60 to be removably attached.

The adaptable leash 60 is coupled to either the front pair of leash fasteners 50 or both the front pair of leash fasteners 50 and the rear pair of leash fasteners 52, depending on the desired use of the adaptable leash 60. To use the adaptable leash 60 as a standard leash, the adaptable leash 60 is coupled to the each of the front pair of leash fasteners 50. In this way, the adaptable leash 60 has a free end that can be extended away from the animal and held by the user. By coupling the adaptable leash 60 to each of the front pair of leash fasteners 50, any force applied to the fabric body 10 by the adaptable leash 60 is evenly distributed across both sides of the fabric body 10. This acts to ensure the comfort and safety of the animal, while still allowing the user to control the animal. To use the adaptable leash 60 as a shoulder strap, the adaptable leash 60 is coupled to both the front pair of leash fasteners 50 and the rear pair of leash fasteners 52. In this way, a closed loop is formed by the adaptable leash 60 and the fabric body 10, allowing the user to secure the present invention around their shoulder. By coupling the adaptable leash 60 to each of the front pair of leash fasteners 50 and each of the rear pair of leash fasteners 52, the weight of the animal is evenly distributed across both sides of the fabric body 10, helping maintain the straight alignment of the animal's spine. This acts to keep the spine of the animal aligned straight and ensures the comfort and safety of the animal while the animal is suspended in the air.

The adaptable leash 60 may comprise a front-end connector 61, a back-end connector 62, and a handle 63. The front-end connector 61 and the back-end connector 62 provide a means for coupling the adaptable leash 60 to the front pair of leash fasteners 50 and the rear pair of leash fasteners 52, respectively. Meanwhile, the handle 63 provides the user with a means to securely grasp the adaptable leash 60, so as to not lose control of the animal. The front-end connector 61 is terminally positioned along the body of the adaptable leash 60, such that one end of the adaptable leash 60 is anchored to the fabric body 10 via the front pair of leash fasteners 50. The handle 63 is positioned opposite the front-end connector 61 about the body of the adaptable strap, such that the adaptable leash 60 may be extended away from the animal and grasped by the user when the adaptable leash 60 is used as a standard leash. In some embodiments, the handle 63 is a loop formed by an end length of the adaptable leash 60. The back-end connector 62 is coupled to the handle 63, such that the handle 63 may be coupled to the rear pair of leash fasteners 52 via the back-end connector 62. In some embodiments, the back-end connector 62 is coupled to the handle 63 such that the back-end connector 62 is able to freely move along the length of the handle 63, when the back-end connector 62 is disconnected from the rear pair of leash fasteners 52. In other embodiments, the back-end connector 62 may be coupled to the handle 63 in a fixed manner. To use the adaptable leash 60 as a standard leash, the front-end connector 61 is coupled to the each of the front pair of leash fasteners 50, while the handle 63 and the back-end connector 62 are left disconnected from the rear pair of leash fasteners 52. Meanwhile, to use the adaptable leash 60 as a shoulder strap, the front-end connector 61 is coupled to each of the front pair of leash fasteners 50, while the back-end connector 62 is coupled to each of the rear pair of leash fasteners 52.

In some embodiments of the present invention, the front-end connector 61 and the rear-end connector are each a spring clip hook. This allows the front-end connector 61 to be securely attached to the front pair of leash fasteners 50 and the back-end connector 62 to be securely attached to the rear pair of leash fasteners 52, as the front-end connector 61 and the back-end connector 62 can only be opened when a force is applied by the user. In some embodiments of the present invention, the front-end connector 61 and the back-end connector 62 are each a swivel spring clip hook. The swivel feature of the front-end connector 61 and the back-end connector 62 prevents the adaptable leash 60 from becoming twisted when in use.

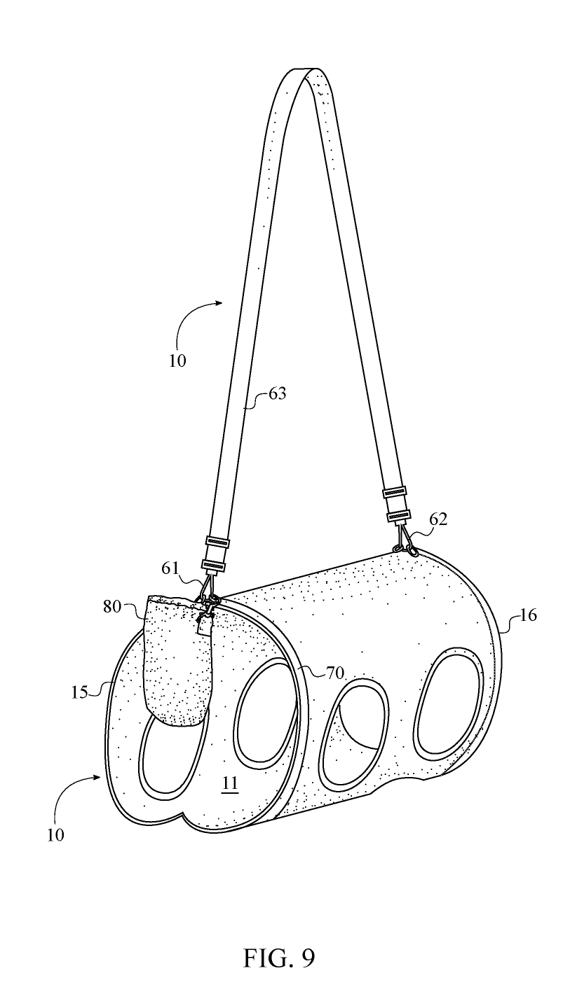

In reference to FIG. 9, the present invention may further comprise an item pouch 80. The item pouch 80 may be any size and shape though the item pouch 80 should be small when compared to the pet holding device. The item pouch 80 provides a means for storing small items, such as a wallet or keys. The item pouch 80 comprises a pouch fastener that is positioned at the top of the item pouch 80, around the opening of the pouch. The pouch fastener allows the item pouch 80 to be coupled to at least one of the front pair of leash fasteners 50 (or at least one of the rear pair of leash fasteners 52). The pouch fastener can by any type of fastener, such as a clip, that allows the item pouch 80 to be temporarily, yet securely attached to the fabric body 10.

To use the present invention, the fabric body 10 is laid flat with the top-inner surface 11 facing upwards. The animal's front legs are then positioned through the front pair of leg holes 30, while the animal's hind legs are positioned through the rear pair of leg holes 32. If the urinary hole 34 needs to be pulled closer to the animal's torso, then the adjustment strap 44 is attached to either the first strap fastener 40 or the second strap fastener 42, wrapped around the torso of the animal and secured to the other fastener. The first wrap fastener 21 is then engaged with the second wrap fastener 22 to secure the fabric body 10 in place around the animal. The adaptable leash 60 can then be attached to the front pair of leash fasteners 50 or both the front pair of leash fasteners 50 and the rear pair of leash fasteners 52 depending on the desired implementation of the present invention.

The present invention can also be utilized as a safety harness when the animal is riding in a vehicle. To use the present invention as such, the animal is placed on the seat of the vehicle with the seatbelt in the connected position. At least one end of the adaptable leash 60 is disconnected from the fabric body 10, such that the adaptable leash 60 can be looped around the closed seatbelt. The free end of the adaptable leash 60 is then secured to the fabric body 10 to secure the animal within the vehicle.

Although the invention has been explained in relation to its preferred embodiment, it is to be understood that many other possible modifications and variations can be made without departing from the spirit and scope of the invention as hereinafter claimed.

What is claimed is:

1. An animal harness comprises:
a fabric body comprising a top-inner surface, a bottom-outer surface, a first side edge, a second side edge, a convex front edge, a back edge, a first wrap fastener, and a second wrap fastener;
the back edge comprising a concave V-shaped section;
the first side edge and the second side edge being parallel to each other;
a front pair of leg holes, a rear pair of leg holes, and a urinary hole traversing through the fabric body;
the urinary hole being positioned in between the front pair of leg holes and the rear pair of leg holes;
the urinary hole and the concave V-shaped section being centered about the sagittal plane of the fabric body;
a first strap fastener and a second strap fastener being adjacently connected to the top-inner surface;
the first strap fastener and the second fastener being positioned adjacent to the urinary hole;
a front pair of leash fasteners and a rear pair of leash fasteners being mounted to the bottom-outer surface;
the first wrap fastener being positioned along the first side edge; and
the second wrap fastener being positioned along the second side edge.

2. The animal harness as claimed in claim 1 comprises:
the front pair of leg holes being positioned adjacent to the convex front edge.

3. The animal harness as claimed in claim 1 comprises:
the rear pair of leg holes being positioned adjacent to the back edge.

4. The animal harness as claimed in claim 1 comprises:
the urinary hole being positioned adjacent to the rear pair of leg holes.

5. The animal harness as claimed in claim 1 comprises:
the back edge further comprising a first convex section and a second convex section;
the first convex section being connected in between the first side edge and the concave V-shaped section; and
the second convex section being connected in between the second side edge and the concave V-shaped section.

6. The animal harness as claimed in claim 1 comprises:
an adjustment strap; and
the adjustment strap being terminally connected to the first strap fastener and the second strap fastener.

7. The animal harness as claimed in claim 1 comprises:
the first strap fastener and the second strap fastener being diametrically opposed from each other about the urinary hole.

8. The animal harness as claimed in claim 1 comprises:
the first strap fastener being positioned in between the first side edge and the urinary hole; and
the second strap fastener being positioned in between the second side edge and the urinary hole.

9. The animal harness as claimed in claim 1 comprises:
the first wrap fastener being adjacently connected to the top-inner surface; and
the second wrap fastener being adjacently connected to the bottom-outer surface.

10. The animal harness as claimed in claim 1 comprises:
an adaptable leash; and
the adaptable leash being coupled to the front pair of leash fasteners.

11. The animal harness as claimed in claim 10 comprises:
the adaptable leash comprises a front-end connector; and
the front-end connector being coupled to the rear pair of leash fasteners.

12. The animal harness as claimed in claim 1 comprises:
an adaptable leash; and
the adaptable leash being coupled to the rear pair of leash fasteners.

13. The animal harness as claimed in claim 12 comprises:
the adaptable leash comprises a handle; and
the handle being coupled to the rear pair of leash fasteners.

14. The animal harness as claimed in claim 12 comprises:
the adaptable leash comprises a back-end connector; and
the back-end connector being coupled to the rear pair of leash fasteners.

15. The animal harness as claimed in claim 1 comprises:
a front edge reinforcement;
the front edge reinforcement being adjacently connected to the bottom-outer surface along the convex front edge; and
each of the front pair of leash fasteners being coupled to an opposing end of the front edge reinforcement.

16. The animal harness as claimed in claim 1 comprises:
a first back edge reinforcement;
the first back edge reinforcement being adjacently connected to the bottom-outer surface along the back edge in between the first side edge and the concave V-shaped section; and
one of the rear pair of leash fasteners being terminally coupled to the first back edge reinforcement adjacent to the first side edge.

17. The animal harness as claimed in claim 1 comprises:
a second back edge reinforcement;
the second back edge reinforcement being adjacently connected to the bottom-outer surface along the back edge in between the second side edge and the concave V-shaped section; and
one of the rear pair of leash fasteners being terminally coupled to the second back edge reinforcement adjacent to the second side edge.

18. The animal harness as claimed in claim 1 comprises:
each of the front pair of leg holes mirroring the other about the sagittal plane.

19. The animal harness as claimed in claim 1 comprises:
each of the rear pair of leg holes mirroring the other about the sagittal plane.

20. The animal harness as claimed in claim 1 comprises:
an item pouch; and
the item pouch being coupled to at least one of the front pair of leash fasteners.
